(19) United States
(12) Patent Application Publication
(10) Pub. No.: US 2014/0026642 A1
(43) Pub. Date: Jan. 30, 2014

(54) CAPACITIVE SENSOR COMPRISING DIFFERING UNIT CELL STRUCTURES

(71) Applicant: John O. O'Connell, Mallow (IE)

(72) Inventor: John O. O'Connell, Mallow (IE)

(21) Appl. No.: 13/557,820

(22) Filed: Jul. 25, 2012

(51) Int. Cl. G01N 27/22

(52) U.S. Cl. 73/31.05

(57) ABSTRACT

A gas and/or humidity sensor system may include two differing capacitive sensor unit cell structures. A first unit cell has a capacitance measurement that is dependent upon capacitance effects that substantially do not extend to the upper reaches of the sensor's gas/humidity sensitive layer and a second unit cell has a capacitance measurement that is dependent upon electric field effects that extend substantially beyond the distance of the electric fields of the first unit cell. The capacitance associated with the electric fields in the upper regions of the gas/humidity sensitive layer may then be obtained to a first order by subtracting the capacitance of the first unit cell from the capacitance of the second unit cell. By subtracting the capacitance, a capacitance associated with the capacitance of the electric fields of the layer (or portion of layer) of interest may be approximated.

### RELATED APPLICATIONS

This application is related to the following application, concurrently filed on the same date as the present application, U.S. patent application Ser. No. 13/557,739, entitled “SENSOR FOR MEASURING HIGH HUMIDITY CONDITIONS AND/OR CONDENSATION”; the disclosure of which is expressly incorporated by reference herein in its entirety.

### TECHNICAL FIELD OF THE INVENTION

The techniques disclosed herein relate to capacitive sensors, and more particularly capacitive sensors utilized for gas (including humidity) concentration measurements.

### BACKGROUND

A wide variety of types of sensors are utilized to measure ambient air conditions such as gas concentrations and relative humidity levels. A capacitive sensor is one known sensor type for measuring gas or humidity concentrations (or other analytes as sensors are not limited to gas and humidity). FIG. 1 illustrates one known technique for forming a capacitive sensor. As shown in the FIG. 1 cross-section, sensor electrodes 102, 104 and 106 may be formed on a substrate 101 to form the “fingers” of an interdigitated capacitive structure. It will be recognized that the capacitive structure may be formed by many electrodes arranged as shown in FIG. 1. Capacitance measurements obtained between the electrodes may be utilized to determine gas or relative humidity levels. Sensor electrodes may be any of a wide variety of conductive materials. Substrate 101 may be any of a wide variety of substrates and may be in one non-limiting example a semiconductor substrate that includes a wide variety of integrated circuit layers (not shown) as is known in the art. For example, U.S. Pat. No. 8,007,167 to Cummins, the disclosure of which is expressly incorporated herein by reference, provides a capacitive sensor formed on an integrated circuit substrate. The sensor electrodes may be covered by a passivation layer 103 and further overlayed with a sensing layer 105. Alternatively, sensing layer 105 may be utilized without the inclusion of a passivation layer 103. In operation, the sensing layer 105 is exposed to the ambient conditions under which a measurement is desired. Thus, at least a portion of the upper surface of the sensing layer 105 may be an air/dielectric layer interface and layer 105 may be considered an ambient condition sensitive layer. Typically the concentration in the ambient air of the analyte being measured impacts the dielectric constant of the sensing layer as differing concentrations in the ambient air will impact the amount of ingress of the analyte into the sensor dielectric material. By measuring the capacitance between the electrodes the gas or relative humidity concentrations in the ambient air may be inferred. As shown in FIG. 1, the electric fields between the electrodes may include fields 110a contained in the passivation layer 103, fields 110b which pass in part through the sensing layer 105, and other parasitic fields (not shown). In operation, the changes in the dielectric constant of the sensing layer are the changes utilized to detect the ambient gas or relative humidity conditions. However, all of the various components of the capacitive measurement may be impacted by temperature changes, chemical contaminants, physical contaminants, etc., thus impacting the accuracy of the detection of the ambient conditions.

It would be desirable to provide an improved capacitive sensor structure and method of utilizing such structures.

### SUMMARY OF THE INVENTION

In one exemplary, non-limiting embodiment, a sensor system may include two differing capacitive sensor unit cell structures. In one embodiment, the sensor system may be a gas and/or relative humidity sensor. A first unit cell structure is constructed such that its capacitance measurement is dependent upon capacitance effects that substantially do not extend to the upper reaches of the sensor's gas/humidity sensitive layer and a second unit cell structure is constructed such that its capacitance measurement is dependent upon electric field effects that extend substantially beyond the electric fields of the first unit cell. The capacitance associated with the electric fields in the mid and/or upper regions of the gas/humidity sensitive layer may then be obtained to a first order by subtracting the capacitance of the first unit cell from the capacitance of the second unit cell. By subtracting the capacitance, a capacitance associated with the capacitance of the electric fields of the layer (or portion of layer) of interest may be approximated while minimizing the effects of other layers, parasitic capacitances, substrate interfaces, the substrate and other stray capacitances. In one embodiment, the electric fields of the first unit cell structure may be confined predominately to layers that do not include the gas/humidity sensitive layer. By subtracting the capacitance, a capacitance associated with the capacitance of the electric fields in the layer of interest (the layer sensitive to a gas or humidity) may be approximated while minimizing the effects of other layers and capacitances. In other embodiments, the number of layers may be minimized such that the electric fields of the second unit cell extend into the gas/humidity sensitive layer but the extent into the gas/humidity layer is to a lesser degree than that the of the first unit cell structure. In such embodiments the subtraction process allows for an isolation of the capacitance effects in the portion of the gas/humidity sensitive layer that is of most interest.

In one exemplary, non-limiting embodiment, a gas and/or humidity sensor is provided in which a capacitive sensor configuration is utilized. The sensor may be comprised of one or more first unit cells and one or more second unit cells. The first unit cell may be constructed to be different from the second unit cell. Moreover, the configuration of the unit cells is such that one unit cell may include capacitance effects of at least a first portion of the gas and/or humidity sensitive layer and other surrounding capacitance effects while the other unit cell includes effects of (1) either none of the gas and/or humidity sensitive layer or smaller portion than the first portion of the gas and/or humidity sensitive layer and (2) the other surrounding capacitance effects. By utilizing measurements from both unit cells, the capacitance effects of the gas and/or humidity sensitive layer (or the most relevant portion of the gas and/or humidity sensitive layer) may be substantially isolated from the effects of the other surrounding capacitance effects. In one exemplary, non-limiting embodiment the utilization of measurements of both unit cells may include a capacitance subtraction process. In one exemplary, non-limiting embodiment the unit cells differ in their periodicity.

In one embodiment, a capacitive gas sensor comprising a gas sensitive material is provided. The gas sensor may be configured to allow the exposure of the gas sensitive material to a gas. A first capacitive sensor cell having first capacitor electrodes is also provided. The first capacitor electrodes have a first set of dimensions, the first capacitive sensor cell being electrically coupled to a first portion of the gas sensitive material. A second capacitive sensor cell having second capacitor electrodes is also provided. The second capacitor electrodes have a second set of dimensions, the second set of dimensions being different from the first set of dimensions, the second capacitive sensor being electrically coupled to a second portion of the gas sensitive material. The second set of dimensions are configured in relation to the first set of dimensions such that electric fields of the second capacitor electrodes extend proportionally further into gas sensitive material than electric fields of the first capacitor electrodes, wherein a combination of the detected capacitance of the first capacitive sensor cell and the second capacitive sensor cell is utilized to obtain a gas sensor measurement.

In yet another embodiment, a method of forming a gas sensor is described. The method may comprise providing a gas sensitive material, the gas sensitive material provided to allow for exposure of the gas sensitive material to a gas. The method may further comprise providing a first set of capacitor electrodes, the first set of capacitor electrodes having a first set of dimensions and providing a second set of capacitor electrodes, the second capacitor electrodes having a second set of dimensions, the second set of dimensions being different from the first set of dimensions. The method further comprises configuring the second set of dimensions to provide proportionally more capacitor electric fields of the second set of capacitor electrodes within the gas sensitive material than the electric fields of the first set of capacitor electrodes and configuring the gas sensor to utilize a combination of the detected capacitance of the first capacitor electrodes and the second capacitor electrodes to obtain a gas sensor measurement.

### DESCRIPTION OF THE DRAWINGS

FIG. 1 is an exemplary illustration of a prior art capacitive sensor.

FIG. 2A is an exemplary cross-section illustration of a unit cell structure having a first periodicity.

FIG. 2B is an exemplary cross-section illustration of a unit cell structure having a second periodicity that is different from the periodicity of the unit cell of FIG. 2A.

FIG. 2C is an exemplary cross-section illustrating an alternative unit cell configuration.

FIGS. 3A-3B are exemplary cross sections of unit cells of differing periodicity as used in an embodiment without a passivation layer under the sensing layer.

FIG. 4 is an exemplary circuit for subtracting the capacitance effects of differing unit cells.

### DETAILED DESCRIPTION OF THE INVENTION

In one exemplary, non-limiting embodiment, the gas and/or humidity sensor system may include two differing capacitive sensor unit cell structures. A first unit cell structure is constructed such that its capacitance measurement is dependent upon capacitance effects that substantially do not extend to the upper reaches of the sensor's gas/humidity sensitive layer and a second unit cell structure is constructed such that its capacitance measurement is dependent upon electric field effects that extend substantially beyond the distance of electric fields of the first unit cell. The capacitance associated with the electric fields in the upper regions of the gas/humidity sensitive layer may then be obtained to a first order by subtracting the capacitance of the first unit cell from the capacitance of the second unit cell. By subtracting the capacitance, a capacitance associated with the capacitance of the electric fields of the layer (or portion of layer) of interest may be approximated while minimizing the effects of other layers, parasitic capacitances, substrate interfaces, the substrate and other stray capacitances. In one embodiment, the electric fields of the first unit cell structure may be confined predominately to layers that do not include the gas/humidity sensitive layer. By subtracting the capacitance, a capacitance associated with the capacitance of the electric fields of the layer of interest (the layer sensitive to a gas or humidity) may be approximated while minimizing the effects of other layers and capacitances. In other embodiments, the number of layers may be minimized such that the electric fields of the second unit cell extend into the gas/humidity sensitive layer but the extent into the gas/humidity layer is to a lesser degree than that the of the first unit cell structure. In such embodiments the subtraction process allows for an isolation of the capacitance effects in the portion of the gas/humidity sensitive layer that is of most interest. As used herein, the term “subtracting” is utilized to convey the concept that the difference between two values is obtained, such as obtaining the difference between the capacitances of two unit cells.

In one exemplary, non-limiting embodiment, a gas and/or sensor is provided in which a capacitive sensor configuration is utilized. The sensor may be comprised of one or more first unit cells and one or more second unit cells. The first unit cell may be constructed to be different from the second unit cell. Moreover, the configuration of the unit cells is such that one unit cell may include capacitance effects of at least a first portion of the gas and/or humidity sensitive layer and other surrounding capacitance effects while the other unit cell includes effects of (1) either none of the gas and/or humidity sensitive layer or smaller portion than the first portion of the gas and/or humidity sensitive layer and (2) the other surrounding capacitance effects. By utilizing measurements from both unit cells, the capacitance effects of the gas and/or humidity sensitive layer (or the most relevant portion of the gas and/or humidity sensitive layer) may be substantially isolated from the effects of the other surrounding capacitance effects. In one exemplary, non-limiting embodiment the utilization of measurements of both unit cells may include a capacitance subtraction process. In one exemplary, non-limiting embodiment the unit cells differ in their periodicity.

In one exemplary embodiment of the techniques described herein, the gas and/or sensor system may include two differing capacitive sensor unit cell structures. One unit cell structure is constructed such that its capacitance measurement is dependent upon capacitance effects that substantially do not include the sensor's gas/humidity sensitive layer and a second unit cell structure is constructed such that its capacitance measurement includes effects of the gas/humidity sensitive layer. The capacitance associated with the electric fields in the gas/humidity sensitive layer may then be obtained to a first order by subtracting the capacitance of the first unit cell from the capacitance of the second unit cell. By subtracting the capacitance, a capacitance associated with the capacitance of the electric fields in the layer of interest (the layer sensitive to a gas or humidity) may be approximated while minimizing the effects of other layers and capacitances. In one exemplary, non-limiting example the gas and/or humidity sensitive layer may be a sensing layer.

In one exemplary, non-limiting embodiment, a gas and/or sensor is provided in which a capacitive sensor configuration is utilized. The sensor may be comprised of one or more first unit cells and one or more second unit cells. The first unit cell may be constructed to be different from the second unit cell. Moreover, the configuration of the unit cells is such that one unit cell may include capacitance effects of a gas and/or humidity sensitive layer and other surrounding capacitance effects while the other unit cell includes the other surrounding capacitance effects but substantially does not include the capacitance effects of the gas and/or humidity sensitive layer. By utilizing measurements from both unit cells, the capacitance effects of the gas and/or humidity sensitive layer may be substantially isolated from the effects of the other surrounding capacitance effects. In one exemplary, non-limiting embodiment the utilization of measurements of both unit cells may include a capacitance subtraction process. In one exemplary, non-limiting embodiment the unit cells differ in their periodicity.

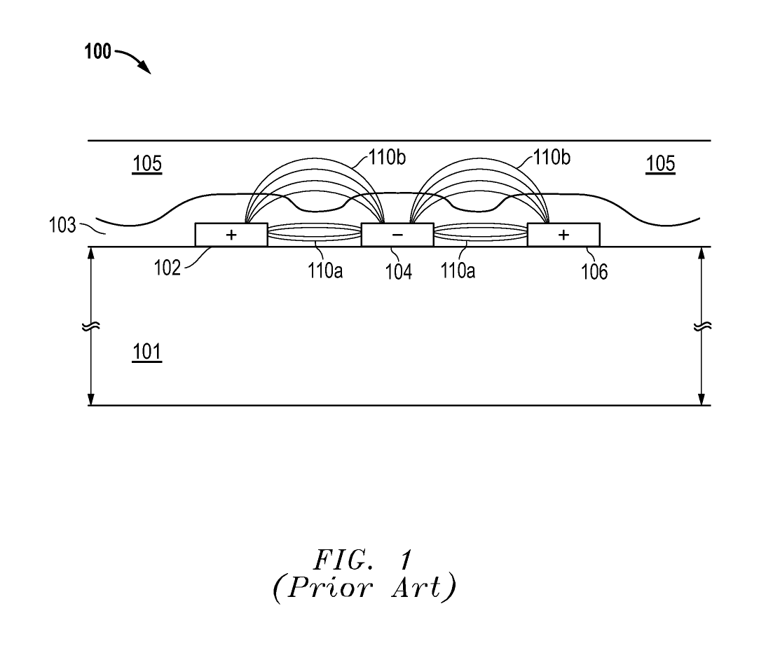

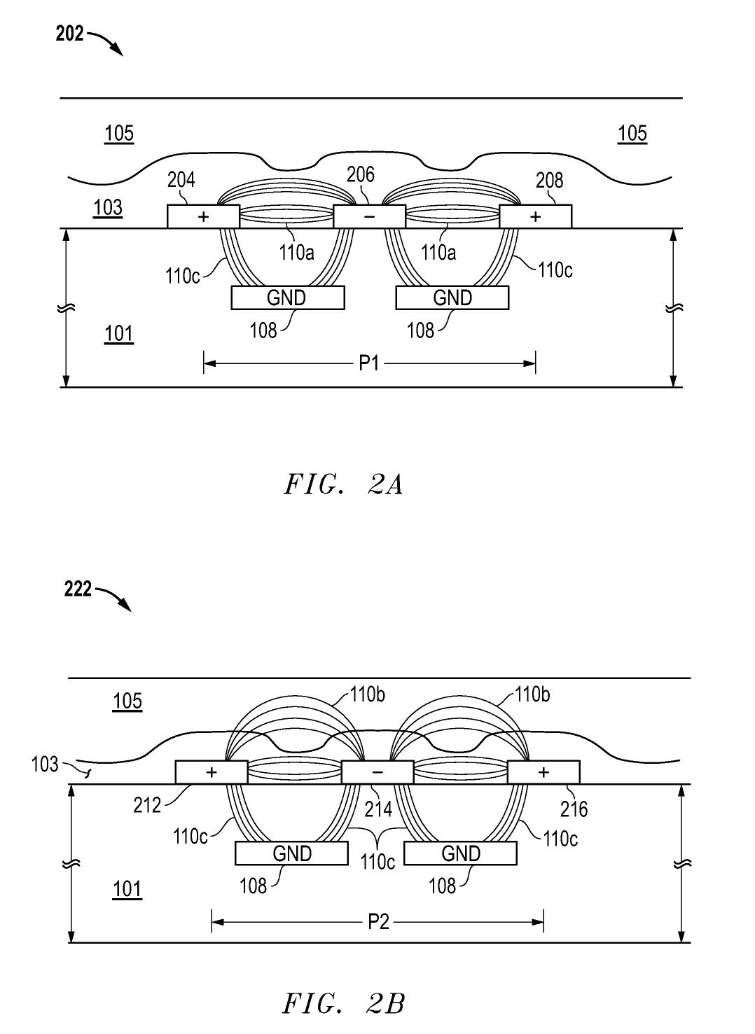

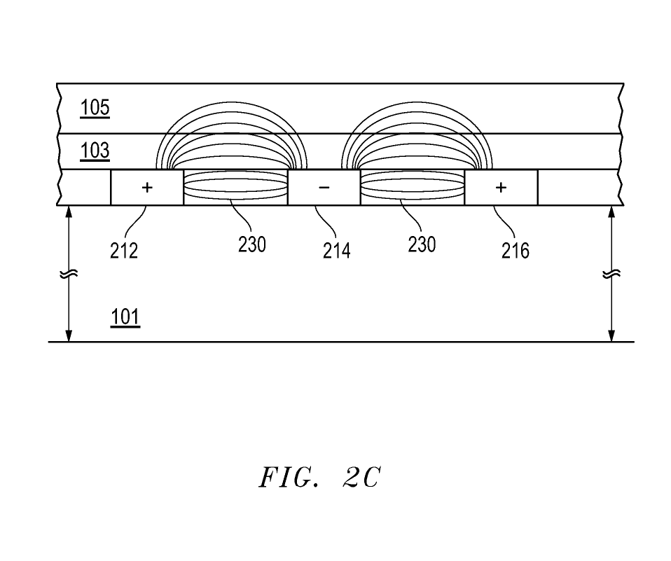

For example, as shown in FIG. 2a, a first unit cell 202 of a capacitive structure is provided. Similar to FIG. 1, a substrate 101, passivation layer 103 and sensing layer 105 may be provided. Ground planes 108 may also be optionally provided. At least a portion of the upper surface of the sensing layer 105 may be an air/dielectric layer interface and layer 105 may be considered an ambient condition sensitive layer. Sensor electrodes 204, 206, and 208 are also provided. The electrodes 204, 206 and 208 may be sized such that that the electric fields lines predominately reside in areas not within the sensing layer 105 as shown by electric field lines 110c and 110a. It is known that for structures such as shown in FIGS. 1 and 2A that approximately 95% of the electric fields associated which such structures are contained in a region having a height of P divided by two, where P is the periodicity of the unit cell as shown in FIG. 2. More particularly, if the gap between electrodes is Wgap and the width of one of the electrodes is Wwidth, then P=2(Wgap+Wwidth). Thus, the sizing of the periodicity P1 of the cell electrodes and the overlying passivation layer of FIG. 2A may be selected such that the electric fields of the cell structure are limited to regions outside of the sensing layer 105 (i.e. P1/2 is sufficient to keep the electric fields predominately out of the sensing layer). It is noted that for ease of illustration, the figures shown herein are not drawn to scale.

Similarly, as shown in FIG. 2B, a second unit cell 222, different from the first unit cell, is provided. The second unit cell 222 may have a second periodicity P2 that is selected large enough such that P2/2 is sufficiently large such that the capacitor structure electric fields will substantially extend into the sensing layer. Thus, as shown in FIG. 2B, sensor electrodes 212, 214 and 216 are configured in a manner such that significant electric fields 110b extend into the sensing layer 103. The unit cell 202 of FIG. 2A and unit cell 222 of FIG. 2B may both be formed on a common sensor substrate and used together as described below in more detail to provide an improved gas or relative humidity sensor measurement as compared to the prior art techniques. In one embodiment, the period (P2) of the second unit cell 222 may be at least 30% larger than the period (P1) of the first unit cell (note for illustration purposes the unit cells of FIGS. 2A and 2B are not meant to be drawn to scale). In another embodiment, the period of the second unit cell may be at least 50% larger than the period of the first unit cell.

The techniques provided herein allow for the isolation of the effects caused by the electric fields 110b in the sensor dielectric so as to improve the gas or relative humidity measurement accuracy. More particularly, measurements may be obtained with two differing unit cells, such as for example, unit cell 202 and unit cell 222 of FIGS. 2A and 2B. In operation, capacitive measurements obtained from unit cell 202 may be subtracted from capacitive measurements obtained from unit cell 222 to provide a value that is substantially associated with the capacitance of the electric field lines in the sensing layer. For example, if capacitance C1 is the capacitance associated with the unit cell 202 having the smaller periodicity P1 and capacitance C2 is the capacitance associated with the unit cell 222 having the larger periodicity P2, then when C1 is subtracted from C2 the residual (or difference) capacitance is the capacitance primarily associated with the electric field lines in the sensor dielectric. This capacitance associated with the electric field lines in the sensor dielectric (Cd) is the value that primarily reflects the ingress of gas and moisture levels and thus provides an improved value to utilize to correlate to the gas or humidity in the ambient conditions. Thus, a capacitance associated with the electric field lines in the dielectric may be estimated to be Cd=C2−C1. In this manner if the two unit cell capacitors are scaled correctly, to a first order the capacitance associated with the electric field lines in the passivation dielectric, ground planes and other parasitic capacitances may cancel out. Consequently, only changes of capacitance in the region of interest (the gas/humidity absorbing layer, the sensing layer) will produce a net change in the measured capacitance.

It will be recognized that the structures and various layers shown in FIGS. 2A and 2B are merely exemplary. For example, numerous integrated circuit processing layers may be included under the sensor electrodes as part of the substrate 101 as known in the semiconductor manufacturing process art (wells, doped layers, isolation layers, transistor gates, interconnects, conductors, vias, etc.). Further, the layers adjacent and above the sensor electrodes may also be varied. For example, as shown in FIG. 2C, the sensor electrodes 212, 214 and 214 may have an adjacent oxide or other dielectric 230. Passivation layer 103 may then be above the dielectric 230 and sensor gas and/humidity sensitive layer 105 may be formed above the passivation layer. Thus, electric fields in the oxide layer 230, passivation layer 103 and sensor gas and/or humidity sensitive 105 may have effects to be considered.

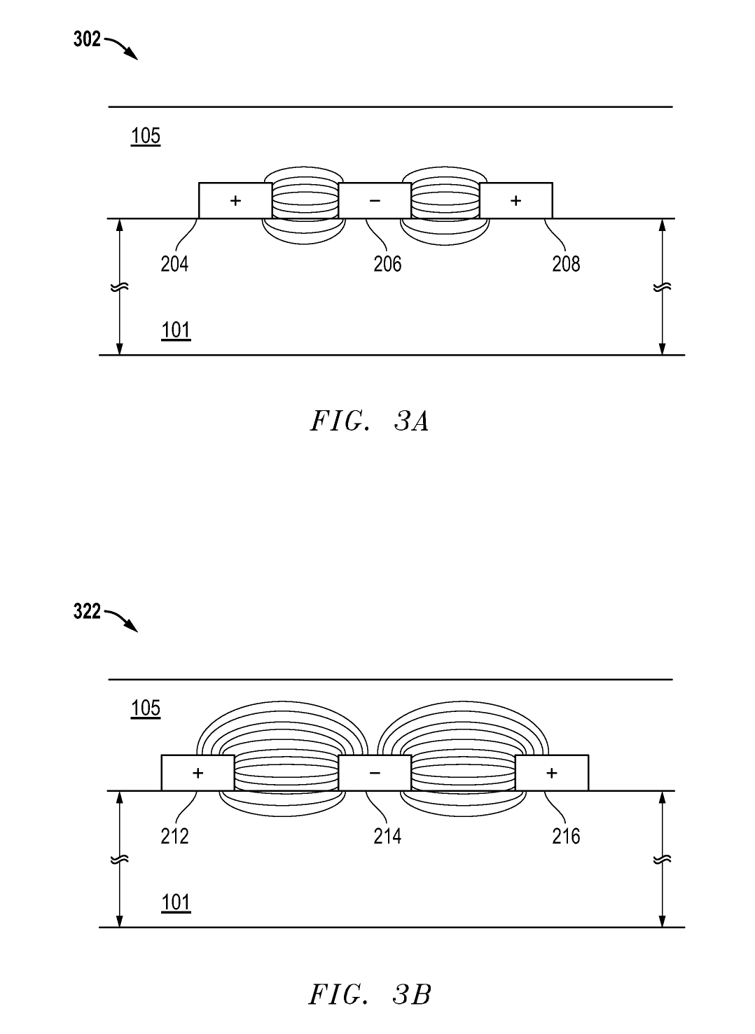

FIGS. 3A and 3B illustrate yet another embodiment of the differing cell techniques described herein. The embodiment of FIGS. 3A-B is similar to that of the embodiment of FIGS. 2A-B except the embodiment of FIGS. 3A-B does not utilize a passivation layer 103. Thus, the sensing layer 105 may be formed around the electrodes without the use of the intervening passivation layer 103. In this embodiment, a portion of electrodes 204 and 208 (note not all of the electrode 204 and 208 are in the unit cell) and electrode 206 form one unit cell 302 and a portion of electrodes 212 and 216 and electrode 216 form another unit cell 322. As shown in FIG. 3A, a unit cell having a smaller period is formed with electrodes 204, 206 and 208. In this cell, the electric fields are predominately contained close to the electrodes deep within the sensing layer. The unit cell of FIG. 3B, however, has a larger period than the unit cell of FIG. 3A, thus providing for an increase electrical field in the upper reaches of the sensing layer 105. In this manner, the effects of the lower portions of the sensing layer 105, fields passing through the substrate 101, any ground planes in the substrate, other substrate interface effects, effects at the interface of the electrodes and other parasitic capacitance effects may be detected with the unit cell of FIG. 3A. The capacitance of the unit cell of FIG. 3A may then subtracted from the detected capacitance of the unit cell of FIG. 3B. The resulting capacitance from such subtraction process will be predominately the capacitance associated with the upper portions of the sensing layer. In this manner, the advantageous of the techniques described above may still be obtained even if layers such as layers 105 and 103 are not present. Thus, the concepts described herein in a broad sense allow for the creation of at least two sets of electric fields, a first set located more close to the electrodes and a second set which extends to a greater distance from the electric field. The capacitance effects detected from the first set of electric fields may be removed from the capacitance effects from the second set. The result of the subtraction process leaves a capacitance value that is dominated by the capacitance of the portions of the sensing layer that are further from the electrodes. This technique provides for a more reliable sensor measurement for determining the particular gas or relative humidity level being detected and a faster sensor.

Though not shown in FIGS. 2C, 3A and 3B, it will be recognized that ground planes may also be present. In one embodiment, the ground planes may be configured to block light from penetrating from the top surface region that is exposed to ambient conditions to circuitry (not shown) that may be formed in the substrate. More particularly, in the sensor unit cell region of the sensor the upper surface of layer 105 may also be exposed to ambient light. Penetration of the light into lower layers below the sensor unit cell capacitor structures may impact circuit operations and performance. In order to prevent such penetration, the ground planes capacitor electrodes may be arranged in a manner that would block impinging light. For some circuits, however, it is not desirable to maintain a continuous ground plane. It address these concerns, for example as shown FIG. 2A, the ground planes 108 may be formed in manner such that the planes are not continuous in regions that associate with the electrodes 204, 206 and 208. Thus, as shown in FIGS. 2A and 2B, the combination of the electrodes and the ground planes would block the ambient light from further penetration into lower level circuitry because the overlap of the ground planes and the electrodes creates in effect a continuous barrier to light penetration.

The techniques described herein to isolate the capacitance effects of the sensor gas and/or humidity sensitive layer may be utilized with all such variations of the overall device layers and structures. Further, any of the layers described herein may be shown for ease of illustration as a single layer, however, it will be recognized that such layers may be formed of a composite of many layers of the same or different material.

A variety of techniques may be utilized to subtract the capacitance effects of the differing unit cells and the concepts disclosed herein need not be limited to a particular technique. For example, the two capacitors can be measured individually and the measurements converted to digital values. The digital values may then be subtracted. Such a technique removes the need for weighting the capacitors. Alternatively when weighted correctly, the capacitors may subtracted utilizing amplifier summing node techniques to provide a value that is representative of subtracted capacitance. The techniques described herein may be utilized by simultaneously measuring the capacitance of each unit cell or alternatively one or the other unit cell may be measured serially before the other.

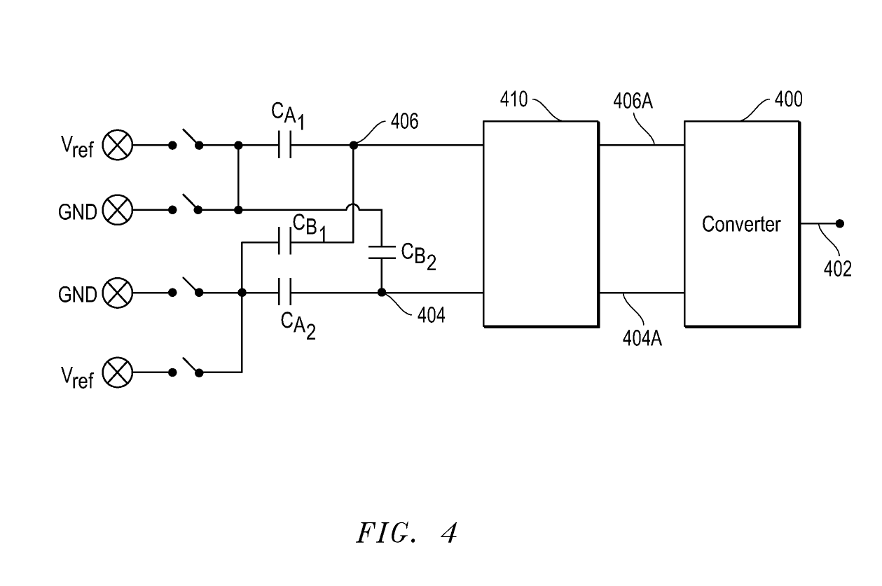

One exemplary technique for subtracting the various capacitances is the amplifier summing node technique shown in FIG. 4. As shown in FIG. 4 an differential summing technique is provided for unit cells having differing capacitances. Capacitors CA1 and CA2 are the capacitances formed from unit cells having a larger period. Capacitors CB1 and CB2 are the capacitances formed from unit cells having a smaller period. Reference voltages Vref and GND are applied as shown to the unit cells. Nodes 406 and 404 are coupled to a switching circuit 410. In operation, in one phase (when CA1 and CB2 are coupled to Vref and CA2 and CB1 are coupled to GND), switching circuitry 410 connects node 406 to node 406A and connects node 404 to node 404A. In another phase (when CA1 and CB2 are coupled to GND and CA2 and CB1 are coupled to Vref), switching circuitry 410 connects node 406 to node 404A and connects node 404 to node 406A. Nodes 406A and 404A are coupled to a converter 400 which converts the detected charge to a digital value at node 402. In one embodiment, converter 400 may be a switched capacitor sigma-delta converter. In this manner, the digital value at node 402 may be representative of a subtraction of capacitance CB from capacitance CA. The example described with reference to FIG. 4 is merely illustrative and it will be recognized that many other techniques may be utilized to obtain a representation of the subtraction of the one unit cell capacitance from another unit cell capacitance, and the disclosure herein is not meant to be limited to any such particular technique.

As described above, the techniques provided herein help remove the effects of the capacitance associated with electric fields that are either outside of the sensor dielectric or outside of the most relevant portions of the sensor dielectric. Removing such effects is particular advantage as these other capacitances may have non-ideality variations related to temperature changes, long term aging, chemical and physical contamination, etc. Thus removing the capacitances associated with the electric fields outside of the most relevant portions of the sensor dielectric helps minimize the impact of variations in such other electric fields caused by temperature, aging, contamination, etc. Furthermore, as many of these degradation effects may change over time, the techniques provided herein provide an improved sensor in that the long term drift of the sensor readings are reduced. The techniques provided herein may also reduce the impact of any degradation in the air/sensing layer interface. Because the region of interest in the sensor structure is reduced to the electric fields in the sensing layer or the portions of the sensing layer of interest, the sensor response time may be reduced.

As described above, capacitors having differing structures are utilized to help isolate the capacitance effects in the sensor material of interest from other capacitance effects caused by surrounding structures of the sensor. One non-limiting illustrative technique of isolating the impact of the material of interest is the differing periodicity of the unit cells. However, the techniques provided herein may be utilized by many other approaches to isolate the capacitance effects in the sensor dielectric material. For example, the periodicity of each cell may remain constant; however, the ratio of Wgap/Wwidth may be changed in each cell so as to change the electric field patterns. Similarly, the thickness of the passivation layer may be different between each unit cell so as to change the electric field patterns. Further, though shown with regard to the presence of substrate ground planes, it will be recognized that such ground planes need not be utilized. Other, techniques for providing differing cells may include changing the layers above or below the sensor electrodes between the two differing cells. Thus, for example, the differing cells may differ in the number of layers above or below a particular cell. In such cases, the cells may be configured to target/isolate the effects of individual sensing layers or particular portions of the sensing layers. The unit cells may also differ in that one cell may have the sensor dielectric directly deposited on the sensor electrodes without the use of a passivation layer and the other cell does not.

Though exemplary embodiments are described herein with regard to unit cells constructed to be different, it will be recognized that the unit cells may be originally constructed in a uniform fashion and then subsequently electrically programmed to be differing. Thus, a programmable unit cell may also be utilized. For example, the unit cells may be comprised of a series of similar capacitive interdigititated “finger” structures. Then various fingers of the structures may be electrically removed or added (switched in or out) so that differing unit cells may be programmable created. Thus, for example, a series of evenly spaced fingers forming electrodes may be utilized to create two different unit cells by one unit cell using each electrode finger while another unit cell has every other electrode finger electrically isolated (switched out of the measurement) and not utilized in the measurement. In this fashion even though all the electrodes were originally formed to have a common periodicity, the sensor may be electrically programmed to provide a first set of electrodes having one periodicity to be used for measurements and a second set of electrodes having a differing periodicity. In yet another programmable embodiment, the electrode fingers for each unit cell may include a set of common electrodes utilized in both unit cells. Thus for example, a serial measurement technique may be utilized in which a first measurement is obtained utilized a first set of electrode fingers which are selected via an electrically programmable technique. Then a second measurement may be obtained utilizing a second set of electrode fingers which were selected via an electrically programmable technique such that the first set of electrode fingers is different than the second set of electrode fingers, though each set may have electrode fingers that are common to the other set. In such a serial approach, having different electrode fingers programmable selected for each measurement provides differing unit cell structures for each measurement that may be selected to isolate the capacitance effects of the sensor's ambient condition sensitive layer. The use of programmable electrode fingers that may optionally switched in and out of the measurement structure may also be utilized to calibrate the sensor. Thus, no matter whether the unit cells are originally constructed to be the same or constructed originally different, programmable switchable cell structures may be utilized to fine-tune or calibrate the overall sensor. It will be recognized that electrically programmable cell structures provides a near endless arrangement of cell structures and that the descriptions provided herein are merely example programmable techniques for creating differing cell structures and that the disclosed herein is not limited to only the techniques described for illustrative purposes.

Thus, the techniques of creating differing electrical field patterns, obtaining measurements from the differing electric field patterns and utilize that data so as to isolate various differing capacitance effects may be achieved in wide ranging variety of manners. In this manner, the benefits of the concepts described herein are not limited to the particular structures shown herein and it will be recognized that the overall concepts disclosed herein are not so limited.

In one embodiment, the portion of the sensor dielectric capacitance that remains after the subtraction process may include electric fields that substantially extend to the ambient air/sensor dielectric interface, such as disclosed in the application concurrently filed on the same date as the present application, U.S. patent application Ser. No. 13/557,739, entitled “SENSOR FOR MEASURING HIGH HUMIDITY CONDITIONS AND/OR CONDENSATION”; the disclosure of which is expressly incorporated by reference herein in its entirety. In such techniques, the capacitance of moisture on the surface interface may be measured by configuring one of the unit cells such that a substantial portion of the electric fields extends to the surface interface. The capacitance of the other unit cell may then be subtracted to provide a more reliable humidity sensor reading that may extend to the detection of condensation. Extrapolating the disclosed techniques even further, in one embodiment, the unit cells could be sized such that the dominate capacitance that remains is the capacitance at or even above the ambient air/sensor layer interface.

Also though shown illustratively herein as straight subtraction, it will be recognized that subtraction incorporates a weighted subtraction such as: Cd=aC2−bC1, where a and be may be weighting functions. Alternatively, the concepts described herein are not merely limited to subtraction techniques. Thus, when given the configuration of two or more differing unit cells, more complex mathematical techniques may also be utilized to isolate the impact of the capacitance effects of the gas and/or humidity sensitive layer. Further, it will be recognized that the capacitors described herein are shown with regard to one unit cell, each differing capacitor structure may be formed from only one unit cell or from many of such unit cells combined. Finally, though the techniques are described with regard to two differing unit cells, the techniques described herein may be extrapolated to the use of three or more unit cells each differing from the others wherein the measurements of the cells is performed in a manner so that the effects of gas or relative humidity changes on the sensor dielectric may be isolated.

In the exemplary differing unit cells of FIGS. 2A and 2B, the electric fields of FIG. 2A are described as predominately not extending into the sensing layer 105. Further, in FIG. 3A the electric fields are not shown extending to the upper portions of the sensing layer 105. It will be recognized that theoretically the electric fields extend in increasing infinitesimally small amounts over great distances. However, the techniques described herein may be advantageous if such electric fields are predominately reduced in the desired portion of the sensor dielectric by at least one-third, and in a preferred embodiment by 50% and in an even more preferred embodiment by two-thirds. Thus in one embodiment, a substantial reduction of the electric fields, a reduction of approximately at least 50%, utilizing the techniques such as described above would be advantageous.

Thus as described herein differing unit cells may be constructed so that the electric field behavior of the unit cells is different. In particular, one unit cell may be constructed such that the portion of the electric filed in the region of the sensing layer (as compared with the total electric field across all regions) is higher than that of the other unit cell. Thus, a first unit cell may create proportionally less of an electric field in the areas of interest (as compared to the areas of non-interest) and a second unit cell may create proportionally more of an electric field in the areas of interest (as compared to the areas of non-interest). Knowing the existence of these differing proportional field strengths may then be utilized to combine measurements of both unit cells in a manner in which the behaviors of the regions of interest are emphasized.

The concepts described herein are not limited to particular materials or particular unit cell sizing. In one exemplary, non-limiting embodiment a sensor in conformance with the embodiment of FIGS. 3A and 3B may be formed. The sensor electrodes may be formed of aluminum, copper, gold, titanium, refractory metals, or any other conductor material as known for potential use in integrated circuit manufacturing, and the sensor ambient sensitive material may be formed of a polyimide, in one example BDMA (benzyldimethylamine) and other polyimides types, such as PBOs, BCB and the like. It will be recognized that many other polyimides or other industry standard ambient sensitive materials may be utilized.

Further, exemplary non-limiting dimensions may include unit cell periodicity of unit cell 302 of about 1 microns to 5 microns (with an exemplary embodiment of Wgap 2 microns and Wwidth 2 microns) and unit cell periodicity of unit cell 322 of about 8 microns to 12 microns (with an exemplary embodiment of Wgap 4 and Wwidth 4). As mentioned above the unit cells may be single unit cells or a combination of unit cells. In one exemplary embodiment, the sensor dielectric thickness may be approximately in the range of 1 micron to 10 microns and the conductive electrodes may have a thickness of 0.5 microns to 2 microns.

In one exemplary embodiment, the sensor structure disclosed herein may be a relative humidity sensor formed on the upper surface of an integrated circuit. The integrated circuit may include circuitry, processors, memory and the like providing gas concentration and/or relative humidity readings based upon the detected changes in the gas and/or humidity sensitive layer. In one exemplary embodiment the upper surface area of the integrated circuit may be approximately 4 mm². A cavity may be formed in the package of the integrated circuit to expose roughly a 0.5 mm² area of the sensor dielectric. Four capacitors may be formed, two unit cells 302 and two unit cells 322 and configured in a differential mode such as shown in FIG. 4. The larger period capacitors may occupy an area of approximately 0.15 mm² per capacitor and the smaller period capacitors may occupy an area of approximately 0.06 mm² per capacitor.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein and certain features of the invention may be utilized independently of the use of other features, all as would be apparent to one skilled in the art after having the benefit of this description of the invention.

1. A capacitive gas sensor comprising:
a gas sensitive material, the gas sensor configured to allow the exposure of the gas sensitive material to a gas;
a first capacitive sensor cell having first capacitor electrodes, the first capacitor electrodes having a first set of dimensions, the first capacitive sensor cell being electrically coupled to a first portion of the gas sensitive material;
a second capacitive sensor cell having second capacitor electrodes, the second capacitor electrodes having a second set of dimensions, the second set of dimensions being different from the first set of dimensions, the second capacitive sensor being electrically coupled to a second portion of the gas sensitive material; and
the second set of dimensions being configured in relation to the first set of dimensions such that electric fields of the second capacitor electrodes extend proportionally further into gas sensitive material than electric fields of the first capacitor electrodes;
wherein a combination of the detected capacitance of the first capacitive sensor cell and the second capacitive sensor cell is utilized to obtain a gas sensor measurement.

2. The gas sensor of claim 1, further comprising circuitry coupled to the first capacitive sensor cell and the second capacitive sensor cell, the circuitry subtracting a capacitance of the first capacitive sensor cell from a capacitance of the second capacitive sensor cell.

3. The gas sensor of claim 2, wherein subtraction of the capacitance of the first capacitive sensor cell provides an approximation of capacitive properties of a region of interest of the gas sensitive material while decreasing capacitance effects of areas of non-interest.

4. The gas sensor of claim 1, the circuitry comprising a summing amplifier.

5. The gas sensor of claim 1, wherein the gas sensor is a relative humidity.

6. The gas sensor of claim 5, further comprising circuitry coupled to the first capacitive sensor cell and the second capacitive sensor cell, the circuitry subtracting a capacitance of the first capacitive sensor cell from a capacitance of the second capacitive sensor cell.

7. The gas sensor of claim 6, wherein subtraction of the capacitance of the first capacitive sensor cell provides an approximation of capacitive properties of a region of interest of the gas sensitive material while decreasing capacitance effects of areas of non-interest.

8. The gas sensor of claim 1, further comprising an intervening layer between gas sensitive material and the first and second capacitor electrodes.

9. The gas sensor of claim 8, wherein the electric fields of the first capacitor electrodes substantially are limited to areas not within the gas sensitive material.

10. The gas sensor of claim 1, the first and second dimensions having a differing periodicity, the periodicity of the second capacitor electrodes being larger than the periodicity of the first capacitor electrodes.

11. The gas sensor of claim 10, wherein the periodicity of the second capacitor electrodes is 30% or more greater than the periodicity of the first capacitor electrodes.

12. The gas sensor of claim 10, wherein the periodicity of the second capacitor electrodes is 50% or more greater than the periodicity of the first capacitor electrodes.

13. A method of forming a gas sensor, comprising:
providing a gas sensitive material, the gas sensitive material provided to allow for exposure of the gas sensitive material to a gas;
providing a first set of capacitor electrodes, the first set of capacitor electrodes having a first set of dimensions;
providing a second set of capacitor electrodes, the second capacitor electrodes having a second set of dimensions, the second set of dimensions being different from the first set of dimensions;
configuring the second set of dimensions to provide proportionally more capacitor electric fields of the second set of capacitor electrodes within the gas sensitive material than the electric fields of the first set of capacitor electrodes; and
configuring the gas sensor to utilize a combination of the detected capacitance of the first capacitor electrodes and the second capacitor electrodes to obtain a gas sensor measurement.

14. The method of claim 13, wherein gas sensor is configured to utilize the combination of the detected capacitance of the first capacitor electrodes and the second capacitor electrodes to obtain a gas sensor measurement by subtracting a first capacitance of the first set of capacitor electrodes from a second capacitance of the second set of capacitor electrodes.

15. The method of claim 13, the gas sensitive material being a humidity sensitive material, the gas sensor measurement being a relative humidity measurement.

16. The method of claim 15, the subtracting utilizing a summing node technique.

17. The method of claim 13, the gas sensitive material being a humidity sensitive material, the gas sensor measurement being a relative humidity measurement.

18. The method of claim 13, the first set of capacitor electrodes having a first periodicity value and the second set of capacitor electrodes having a second periodicity value, the first periodicity value being a smaller than the second periodicity value.

19. The gas sensor of claim 18, wherein the second periodicity value is 30% or more greater than the first periodicity value.

20. The method of claim 13, the combination of the detected capacitances the first capacitor electrodes and the second capacitor electrodes to allowing the gas sensor measurement to be focused upon a region of interest.

21. The method of claim 20, the differing first and second dimensions lessons the impact of undesirable parasitic capacitances or interface capacitance effects within the gas sensor measurement.

22. The method of claim 13, further comprising providing an intervening layer between the gas sensitive material and the first and second capacitor electrodes.

23. The method of claim 13, wherein the combination of the detected capacitances the first capacitor electrodes and the second capacitor electrodes lessens the effects of electric fields that are outside the most relevant portions of the gas sensitive material.
